(19) United States
(12) Patent Application Publication
(10) Pub. No.: US 2022/0404621 A1
(43) Pub. Date: Dec. 22, 2022

(54) MODERATING A USER?S SENSORY EXPERIENCE WITH RESPECT TO AN EXTENDED REALITY

(71) Applicant: Telefonaktiebolaget LM Ericsson (publ), Stockholm (SE)

(72) Inventors: Gregoire PHILLIPS, La Jolla, CA (US); Paul MCLACHLAN, San Francisco, CA (US); Lauren Ann GILBERT, La Jolla, CA (US)

(73) Assignee: Telefonaktiebolaget LM Ericsson (publ), Stockholm (SE)

(21) Appl. No.: 17/277,941

(22) PCT Filed: Dec. 22, 2020
(86) PCT No.: PCT/SE2020/051249

§ 371 Date: Mar. 19, 2021

(51) Int. Cl. G02B 27/01; G06T 19/00; G06F 3/01

(52) U.S. Cl. CPC G02B 27/017; G06T 19/006; G06F 3/011

(57) ABSTRACT

A method, performed by an XR rending device (124) having a sensory sensitivity control device (199), for moderating a first user's sensory experience with respect to an XR environment. The method includes obtaining first user preference information for the first user, the first user preference information indicating that at least one sensory experience should be modified. The method includes obtaining XR scene configuration information for use in generating XR content, wherein the XR scene configuration information indicates that the XR content should or must include data corresponding to a particular sensory stimulation. The method includes generating XR content for the first user based on the first user preference information and the XR scene configuration information, and providing the generated XR content to an XR user device worn by the first user, wherein the XR user device comprises one or more sensory actuators for producing one or more sensory stimulations.

### TECHNICAL FIELD

This disclosure relates to methods, devices, computer programs and carriers related to extended reality (XR).

### BACKGROUND

Extended Reality

Extended reality (XR) uses computing technology to create simulated environments (a.k.a., XR environments or XR scenes). XR is an umbrella term encompassing virtual reality (VR) and real-and-virtual combined realities, such as augmented reality (AR) and mixed reality (MR). Accordingly, an XR system can provide a wide variety and vast number of levels in the reality-virtual reality continuum of the perceived environment, bringing AR, VR, MR and other types of environments (e.g., mediated reality) under one term.

Augmented Reality (AR)

AR systems augment the real world and its physical objects by overlaying virtual content. This virtual content is often produced digitally and incorporates sound, graphics, and video. For instance, a shopper wearing AR glasses while shopping in a supermarket might see nutritional information for each object as they place the object in their shopping carpet. The glasses augment reality with additional information.

Virtual Reality (VR)

VR systems use digital technology to create an entirely simulated environment. Unlike AR, which augments reality, VR is intended to immerse users inside an entirely simulated experience. In a fully VR experience, all visuals and sounds are produced digitally and does not have any input from the user's actual physical environment. For instance, VR is increasingly integrated into manufacturing, whereby trainees practice building machinery before starting on the line. A VR system is disclosed in US 20130117377 A1.

Mixed Reality (MR)

MR combines elements of both AR and VR. In the same vein as AR, MR environments overlay digital effects on top of the user's physical environment. However, MR integrates additional, richer information about the user's physical environment such as depth, dimensionality, and surface textures. In MR environments, the user experience therefore more closely resembles the real world. To concretize this, consider two users hitting an MR tennis ball on a real-world tennis court. MR will incorporate information about the hardness of the surface (grass versus clay), the direction and force the racket struck the ball, and the players' height.

XR User Device

An XR user device is an interface for the user to perceive both virtual and/or real content in the context of extended reality. An XR device has one or more sensory actuators, where each sensory actuator is operable to produce one or more sensory stimulations. An example of a sensory actuator is a display that produces a visual stimulation for the user. A display of an XR device may be used to display both the environment (real or virtual) and virtual content together (i.e., video see-through), or overlay virtual content through a semi-transparent display (optical see-through). The XR device may also have one or more sensors for acquiring information about the user's environment (e.g., a camera, inertial sensors, etc.). Other examples of a sensory actuator include a haptic feedback device, a speaker that produces an aural stimulation for the user, an olfactory device for producing smells, etc.

Object Recognition

Object recognition in XR is mostly used to detect real world objects for triggering digital content. For example, the user may look at a fashion magazine with augmented reality glasses and a video of a catwalk event would play in a video for the user. Sound, smell, and touch are also considered objects subject to object recognition.

The Internet-of-Things (IoT)

The “Internet-of-Things” is the interconnection of computing devices embedded into ordinary items and systems via the Internet. The IoT enables the application of computing capabilities to the functioning of any device capable of connecting to the Internet, thereby facilitating a wide range of possible remote user interactions.

5G

First launched commercially in 2019, 5G, including New Radio (NR) and 5G Core has several key technological improvements over earlier generations of mobile network standards. As defined by the 3rd Generation Partnership Project (3GPP), 5G NR and 5GC standards include one millisecond end-to-end latency; 20 gigabit-per-second (Gbps) download speeds; and 10 Gbps upload speeds. Paired with emerging edge computing businesses, which brings compute to the edge of the network to minimize latency, and mature cloud infrastructure (hereinafter, “edge-cloud”), 5G will create a flood of new market opportunities for interactive user experiences and media. Some analysts predict that XR will be the key experience 5G unlocks.

Network latency and speed have hitherto limited widespread adoption of XR applications. Higher latency, such as that found with current 3G/4G networks, means that product designers at least sometimes have been unable to rely on the edge-cloud for computation. Beyond potentially poor user experience, significant latency and jitter in overlay movement and/or placement can cause users to feel motion sickness (a.k.a., cyber sickness or simulator sickness). 3G/4G′s slower speeds also mean that XR headsets stream highly compressed data, reducing overlays' concordance with reality and potentially harming the performance of object detection and simultaneous localization and mapping (SLAM) algorithms.

Advances in the generation and identification of the sensory environment have constituted some of the most consequential breakthroughs in XR technology in the past decade. The ability for XR devices to detect and correctly identify objects in a user's visual field has, indeed, made possible the safe physical mapping and simulation of motion in XR space while also making accurately placed XR mappings possible. Moreover, innovation in the ability to identify, sequence, and transform audio feedback in virtual and augmented reality has greatly expanded the horizons of XR's applications in entertainment and beyond. Finally, significant advances in tactile interaction, including haptic and even thermal feedback, have introduced the potential for interactive sensory experiences with touch components; adding a new and exciting dimension to XR's growth in the decade to come.

Current XR technologies are predominantly limited to devices tethered to local networks, allowing for user control and low-latency connectivity at the expense of dynamic interactivity with outside environments and users in an extended network. With the expansion of 5G NR and the proliferation of edge-cloud computing into the commercial IoT beyond the household, the proliferation of XR technologies beyond these limits promises to expand the horizon of interactive experiences (visual, audio, tactile, and beyond) that users may enjoy in extended virtual and augmented reality environments outside of their homes.

### SUMMARY

An object of the invention is to enable improved security for a user of an XR system.

Certain challenges presently exist. For instance, while the spread of XR experiences carries with it great promise, it also introduces potential risks for individuals with sensitivity to certain types of sensory stimulations. These users may encounter potentially harmful stimuli in their surrounding XR or physical environments, and these users lack the control over the external environment necessary to moderate (e.g., prevent or attenuate) their sensory experience. Without intervention, overstimulation of users with disabilities or health conditions may result in serious injury or even death.

In short, there currently exists no mechanism for users to moderate the different types of sensory stimulation imposed upon them by outside forces in the XR environment. This potentially limits their ability to effectively engage with XR environments in a fulfilling way. Also, there exists no architecture for mapping out potentially dangerous or otherwise triggering sensory environments to sensitive individuals in the greater XR environmental network, or in physical environments in which individuals may use their XR devices. For example, individuals navigating public or commercial spaces with an integrated XR overlay may not have any way of knowing that they are about to be exposed to potentially harmful stimulus based on an environmental feature or the actions of another user in the XR environment.

Accordingly, in one aspect there is provided a method, performed by an XR rendering device having a sensory sensitivity control device, for moderating a first user's sensory experience with respect to an XR environment with which the first user is interacting. The method includes obtaining first user preference information for the first user, the first user preference information indicating that at least one sensory experience should be modified (e.g., blocked, reduced, or increased). The method also includes obtaining XR scene configuration information for use in generating XR content, wherein the XR scene configuration information indicates that the XR content should or must include data corresponding to a particular sensory stimulation. The method further includes generating XR content for the first user based on the first user preference information and the XR scene configuration information. The method also includes providing the generated XR content to an XR user device worn by the first user, wherein the XR user device comprises one or more sensory actuators for producing one or more sensory stimulations.

In another aspect there is provided a computer program comprising instructions which when executed by processing circuitry of a XR rendering device causes the XR rendering device to perform the method. In another aspect there is provided a carrier containing the computer program, wherein the carrier is one of an electronic signal, an optical signal, a radio signal, and a computer readable storage medium. In another aspect there is provided a XR rendering device, where the XR rendering device is adapted to perform the method. In some embodiments, the XR rendering device includes processing circuitry and a memory containing instructions executable by the processing circuitry, whereby the XR rendering device is operative to perform the method.

In another aspect there is provided a method, performed by a sensory sensitivity control device (SSCD), for moderating a first user's sensory experience with respect to an XR environment with which the first user is interacting. The method includes obtaining first user preference information for the first user, the first user preference information indicating that at least one sensory experience should be modified (e.g., blocked or reduced or increased). The method also includes obtaining XR content produced by an XR rending device. The method further includes modifying the XR content based on the first user preference information to produce modified XR content, wherein the modified XR content is translated by an XR user device into at least one sensory stimulation.

In another aspect there is provided a computer program comprising instructions which when executed by processing circuitry of an SSCD causes the SSCD to perform the method. In another aspect there is provided a carrier containing the computer program, wherein the carrier is one of an electronic signal, an optical signal, a radio signal, and a computer readable storage medium. In another aspect there is provided an SSCD, where the SSCD is adapted to perform the method. In some embodiments, the SSCD includes processing circuitry and a memory containing instructions executable by the processing circuitry, whereby the SSCD is operative to perform the method.

Advantageously, the sensory sensitivity control device disclosed herein allow users to control their exposure to XR and certain real-world stimulation by moderating (e.g., blocking or filtering) certain stimuli (e.g., visual, audio, tactile, etc.). By presenting users with options for manually or automatically establishing desirable sensory parameters in their environment while using an XR device, the sensory sensitivity control device provides users with a menu of options for safely and comfortably using XR technology. These features open the door for the safe use of XR technology by the over 1 billion people worldwide—and several million in the United States alone—living with disabilities such as autism-spectrum conditions or epilepsy that make them sensitive to different types of visual, audio, or tactile stimulation, while also opening the door to a greater degree of comfort to non-disabled users who may have preferences over the intensity of their sensory experiences. By eliminating the barrier to safety and comfort for potential XR users, this disclosure greatly expands the marketable horizon for XR experiences running the gamut from entertainment to the workplace to assisted living.

In addition to the these generalized benefits, the sensory sensitivity control device also provide a very specific solution for individuals with autism-spectrum sensory deficits and triggers to identify threats to their well-being in the sensory environments around them while providing a first line of defense against sensory overstimulation while using an XR device. Given the wide prevalence of sensory sensitivity and vulnerability to sensory overstimulation in the autistic community, this disclosure has the potential to drastically improve the welfare of hundreds of millions of individuals with autism-spectrum conditions worldwide.

### BRIEF DESCRIPTION OF THE DRAWINGS

The accompanying drawings, which are incorporated herein and form part of the specification, illustrate various embodiments.

FIG. 1 illustrates an XR system according to an embodiment.

FIG. 2 illustrates an XR headset according to an embodiment.

FIGS. 3A-3C illustrate examples use cases.

FIGS. 4A-4C illustrate an example use case.

FIG. 5 illustrates an example of a user interface.

FIG. 6 is a flowchart illustrating a process according to an embodiment.

FIG. 7 is a flowchart illustrating a process according to an embodiment.

FIG. 8 illustrates an XR rendering device according to an embodiment.

FIG. 9 illustrates an SSCD according to an embodiment.

### DETAILED DESCRIPTION

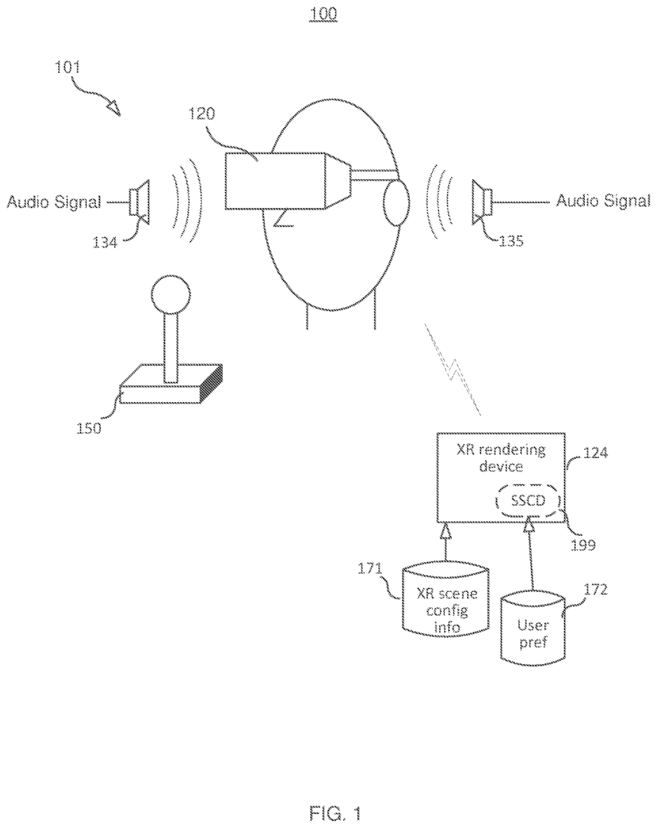

FIG . 1 illustrates an extended reality (XR) system 100 according to some embodiments. As used herein, XR is an umbrella term encompassing virtual reality (VR) and real-and-virtual combined realities, such as augmented reality (AR) and mixed reality (MR). As shown in FIG. 1, XR system 100 includes an XR user device 101 and an XR rendering device 124, which may include a sensory sensitivity control device (SSCD) 199. In the example shown in FIG. 1, XR rendering device 124 is located remotely from XR user device 101 (e.g., XR rendering device 124 may be a component of a base station (e.g., a 4G base station, a 5G base station, a wireless local area network (WLAN) access point, etc.) or other node in a radio access network (RAN)). The XR rendering device 124 may for example be a part of the 5G baseband unit or virtualized baseband function of a 5G base station or any future base station. Accordingly, in this embodiment, XR user device 101 and XR rendering device 124 have or are connected to communication means (transmitter, receiver) for enabling XR rendering device 124 to transmit XR content to XR user device 101 and to receive input from XR user device 101 (e.g., input from sensing units 221 and 222, described below). Any protocol may be used to transmit XR content to XR user device 101. For instance, video and/or audio XR content may be transmitted to XR user device 101 using, for example, Dynamic Adaptive Streaming over the Hypertext Transfer Protocol (DASH), Apple Inc.'s HTTP Live Streaming (HLS) protocol, or any other audio/video streaming protocol. As another example, non-audio and non-video XR content (e.g., instructions, metadata, etc.) may be transmitted from XR rendering device 124 to XR user device 101 using, for example, HTTP or a proprietary application layer protocol running over TCP or UDP. For instance, the XR user device 102 may transmit an HTTP GET request to XR rendering device 124, which then triggers XR rendering device 124 to transmit an HTTP response. The body of this response may be an extensible markup language (XML) document or a Javascript Object Notation (JSON) document. In such an embodiment, XR rendering device 124 may be an edge-cloud device and XR rendering device 124 and XR user device 101 may communicate via a 5G network, which enables very low latency, as described above. In other embodiments XR rendering device 124 may be a component of XR user device 101 (e.g., XR rendering device 124 may be a component of an XR headset 120).

In the embodiment shown in FIG. 1, XR user device 101 includes: XR headset 120 (e.g., XR goggles, XR glasses, XR head mounted display (HMD), etc.) that is configured to be worn by a user and that is operable to display to the user an XR scene (e.g., an VR scene in which the user is virtually immersed or an AR overlay), speakers 134 and 135 for producing sound for the user, and one or more input devices (e.g., joystick, keyboard, touchscreen, etc.), such as input device 150, for receiving input from the user (in this example the input device 150 is in the form of a joystick). In some embodiments, XR user device 101 includes other sensory actuators, such as an XR glove, an XR vest, and/or an XR bodysuit that can be worn by the user, as is known in the art.

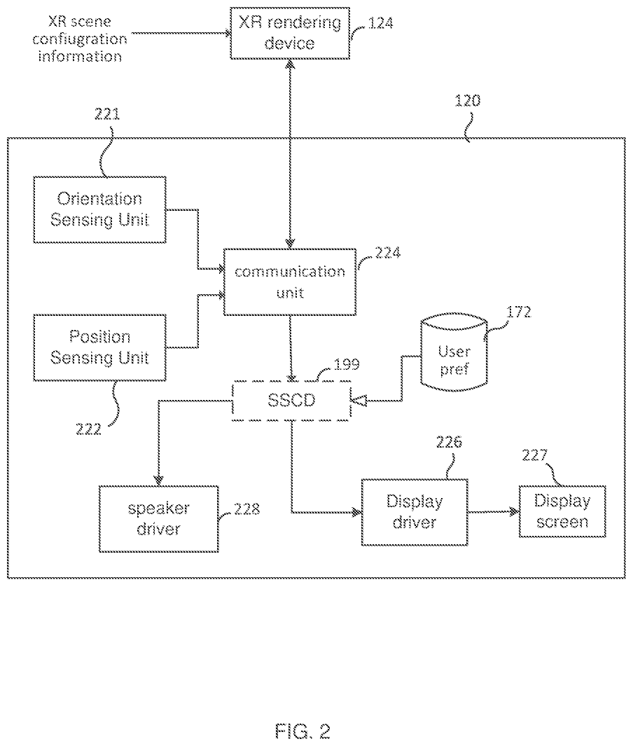

FIG. 2 illustrates XR headset 120 according to an embodiment. In the embodiment shown, XR headset 120 includes an orientation sensing unit 221, a position sensing unit 222, and a communication unit 224 for sending data to and receiving data from XR rendering device 124. XR headset 120 may further include SSCD 199. Orientation sensing unit 221 is configured to detect a change in the orientation of the user and provides information regarding the detected change to XR rendering device 124. In some embodiments, XR rendering device 124 determines the absolute orientation (in relation to some coordinate system) given the detected change in orientation detected by orientation sensing unit 221. In some embodiments, orientation sensing unit 221 may be or comprise one or more accelerometers and/or one or more gyroscopes.

In addition to receiving data from the orientation sensing unit 221 and the position sensing unit 222, XR rendering device 124 may also receive input from input device 150 and may also obtain XR scene configuration information (e.g., X rending device may query a database 171 for XR scene configuration information). Based on these inputs and the XR scene configuration information, XR rendering device 124 renders a XR scene in real-time for the user. That is, in real-time, XR rendering device 124 produces XR content, including, for example, video data that is provided to a display driver 126 so that display driver 126 will display on a display screen 127 images included in the XR scene and audio data that is provided to speaker driver 128 so that speaker driver 128 will play audio for the using speakers 134 and 135. The term “XR content” is defined broadly to mean any data that can be translated by an XR user device into perceivable sensations experienced by the user. Accordingly, examples of XR content include not only video data and audio data, but also commands for instructing a sensory actuator to produce a sensory input (e.g., smell, touch, light) for the user.

1. Moderating Sensory Experiences

SSCD 199, whether it is included in XR rendering device 124 and/or XR user device 101, enables users to control the sensory inputs of their virtual and real-world environments. For example, through a user interface generated by SSCD 199, the user may specify user preference information (which may be stored in user preference database 172) specifying which sensory experiences they would like to control in their virtual and real-world environments either through a manual, automatic, or semi-automatic process. For instance, the user may want to control the user's exposure to flashing lights because the user is sensitive to flashing lights. Next, the SSCD 199 may identify the features of these sensory experiences from a library of sensory experiences in order to accurately identify these experiences in virtual and physical environments. The SSCD 199 then may scan the immediate virtual and/or physical environments for this stimulus during the duration of user's use of XR user device 101 using its existing sensors (e.g., a camera). When an undesirable stimulus is detected, it is moderated (e.g., blocked out of the users environment or filtered using visual, audio, or tactile augmentation generated by XR user device 101). For example, in one embodiment, SSCD 199 has access to real-time train position information and can use this information to protect a user who is standing on a train platform and who is very sensitive to loud noises by, for example, using the real-time train position to predict when the train will pass the user and automatically adjust the user's headphone at that time so that the headphones will cancel out any noise from any passing train. Similarly the user may of course not have to be stationary, but could for example sit in a moving train himself/herself, so that the prediction is done based on the position of two moving trains. In addition to controls for the immediate environment, the SSCD 199 may access a spatial map of places likely to contain the undesired sensory stimuli through access to libraries of shared user and commercial data in the edge cloud.

1.1 Using XR to Moderate Sensory Experiences in Virtual Environments

The SSCD 199 can be used to moderate sensory experiences in virtual environments in at least two ways. First, the SSCD 199 can direct XR rendering device 124 to make changes to the XR content directly by removing or modulating features with sensory qualities that users specify as undesirable. That is, for example, based on user preference information for the user, which information may be obtained from a user preference database 172, SSCD 199 directs XR rendering device 124 to make changes to XR content for the user. Second, the SSCD 199 can modify the XR content produced by XR rendering device 124 to make changes to the way features of the virtual environment are experienced (e.g., maintaining the same qualities and information in the generation or rendering of the virtual environment but changing only the way that users interact in that environment).

The first method involves a direct intervention by the SSCD 199 into the generation or rendering of an XR environment. In this process, the SSCD 199 would simultaneously identify and moderate the visual, auditory, tactile, and/or other sensory experience as the XR device generates or renders the environment for user interaction. This method requires the necessary permissions and degree of control for the SSCD 199 to edit or change content in the XR environment as it is being generated.

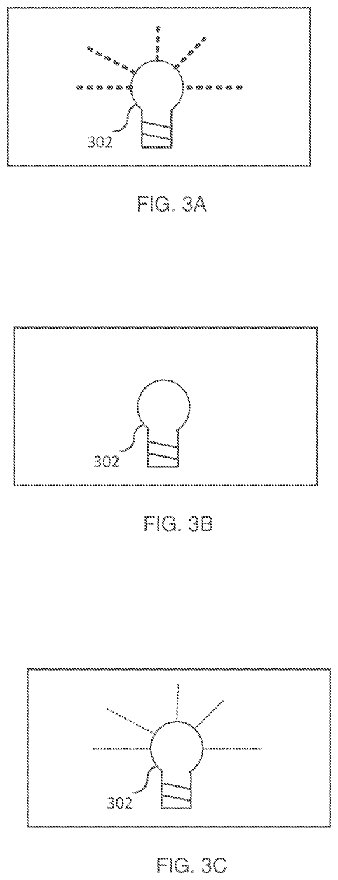

FIGS. 3A, 3B, and 3C provides an example of direct intervention by the SSCD 199 to moderate a virtual visual sensory experience. In this simplified illustration, SSCD 199 has detected that the XR configuration information indicates that the XR content should or must include data corresponding to a particular sensory stimulation (which in this case is a light source 302 that is strobing). SSCD 199 has also determined, based on the user's preference information, that the user has indicated that strobing lights should be moderated, such as, blocked or reduced in intensity or otherwise changed (e.g., changing the frame rate of the video). Accordingly, the SSFC 199 causes XR rendering device 124 to generate the XR content such that the XR content takes into account the user's stated preference. Depending on the user's moderation preferences within the SSCD 199, the SSCD 199 may cause XR rendering device 124 to moderate this sensory experience in one of two ways. For example, as shown in FIG. 313, XR rendering device 124 may completely remove the violating sensory experience (i.e., the strobing of the light source) when generating the XR content for the XR scene. That is, in the example shown in FIG. 3B, the light source 302 is not emitting any light. Alternatively, as shown in FIG. 3C, XR rendering device 124 may instead reduce the intensity of the experience by altering features of the sensory experience in the rendering of the XR content to conform to the user's sensory preferences. In this illustration, XR rendering device 124 has slowed the frame rate of the strobing effect, but preserved the emission of light from the light feature.

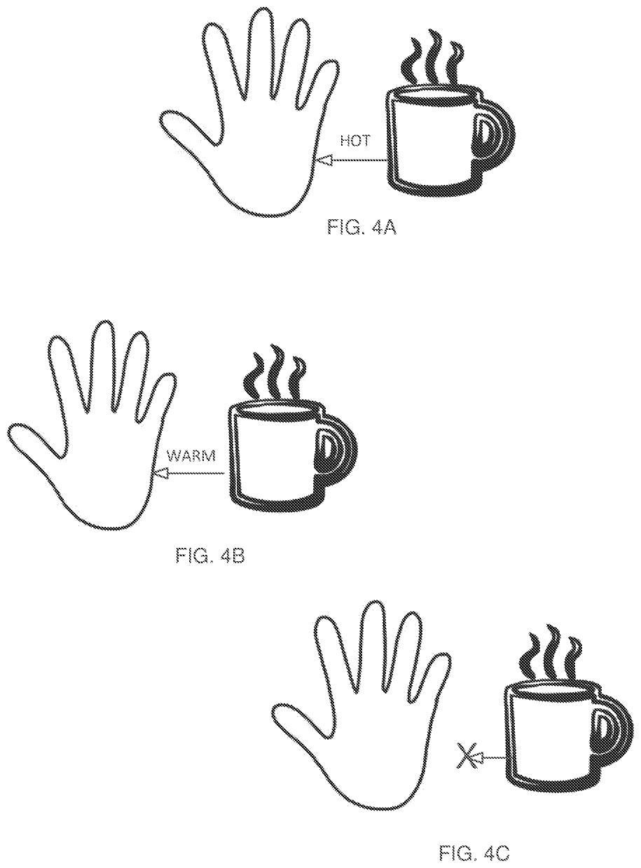

Rather than controlling XR rendering device 124 such that, for example, the XR content produced by XR rendering device 124 does not include any content that violates the user's preferences, the second method involves SSCD 199 modifying the XR content generated by XR rendering device 124. In this way, SSCD 199 preserves the sensory components of the virtual environment in the rendering of an XR experience, but changes the way that XR user device 101 process the XR content in a way that either removes or reduces the sensory stimulation experience by the user. This is illustrated in FIGS. 4A, 4B, and 4C.

In this illustrated example, SSCD 199 obtains the XR content generated by XR rendering device 124 and detects that the XR content includes data corresponding to a particular sensory stimulation (e.g., heat from a coffee cup 402). SSCD 199 also obtains the user preference information (e.g., retrieves the user preference information from a database 172) and determines that that the user has a preference regarding heat sensory stimulations (e.g., the user is sensitive to heat and does not want to experience any temperature above a set amount (e.g., room temperature). Accordingly, after determining that if XR user device 101 were to translate the XR content into a virtual environment the user would experience heat above the user's threshold, the SSCD 199 may modify the XR content so that when XR user device 101 translates the XR content into a virtual environment the user would not experience heat above the user's threshold. For example, depending on the user's moderation preferences within the SSCD 199, the SSCD 199 may instruct the heat sensation-generating device (e.g., XR glove having a built-in heating element) to moderate this sensory experience in one of two ways.

For example, as shown in FIG. 4B, SSCD 199 may instruct the heat sensation-generating device to conform to conform to the user's sensory preferences (e.g., not produce any heat sensation above the user stated heat threshold). In this illustration, the SSCD 199 has instructed XR user device 101 to change the temperature sensation from hot to warm.

As another example, as shown in FIG. 4C, SSCD 199 may instead completely remove the violating sensory experience when generating the XR environment. In this illustration, the XR device has preserved the sensory data in the environment, but changed the way the wearable sensory detection overlay reads that data to exclude the temperature sensation entirely.

1.2 Using XR to Moderate Sensory Experiences in Real-World Environments

In some embodiments, SSCD 199 can also be used to moderate sensory experiences in real-world environments using sensory actuating devices—from common devices such as headphones and eye coverings to any other device that can change an user's perception of their sensory environment—to intercept and change a sensory input before the user experiences the sensory input.

Accordingly, in some embodiments, SSCD 199 receives data from one or more sensors of XR user device 101 (e.g., camera, microphone, heat sensor, touch sensor, olfactory sensor) that take in sensory stimuli from the surrounding real-world environment. SSCD 199 would then leverage this sensory awareness together with the user preference information to detect whether the user would be exposed in the real-world to a stimuli that the user seeks to avoid and then to take the appropriate remedial action (e.g., darken the user's glasses if the user would be exposed to a strobing light or use noise cancelling headphones to cancel unwanted noise). SSCD 199 can be local to XR user device 101 or it could be in the edge-cloud and communicate with XR user device 101 using a low latency network (e.g., 5G NR).

The SSCD 199 can moderate real-world sensory experiences by changing the way sensory stimuli is experienced by the user. Moderating such experiences in the real world poses a unique challenge. Unlike in a virtual context, users cannot always easily change the way their physical environment is generated, and must therefore rely on sensory modifying devices to counteract or change the experience. This is like the method of indirect moderation described in the virtual context above and illustrated in FIGS. 4A-4C. Once the SSCD 199 has identified an undesirable sensory stimulation (via manual, automatic, or semi-automatic means, as described below), it directs a paired sensory device or sensory actuator to moderate that sensation—either by preventing the user from experiencing it entirely or by countering/modulating the experience by changing the way an user experiences it through the device's or actuator's function.

2.0 Setup of Controls

The user's input specifying the types of sensations—sound, visual features, haptics, sensory feedback, or even smells or tastes—the user would like the system to moderate or augment is needed to set up sensory sensitivity controls. In one embodiment, a simple user interface is employed through which the user is granted access to a series of sensory domains and given options for which experiences within those domains they may moderate using their available XR user device and any supplemental devices they may have connected. This user interface allows the user to set the parameters for sensory adjustments locally on the XR device before pushing any requests for adjustment to be made 1) with other users through the edge-cloud or 2) with any third-party entities via an outside API.

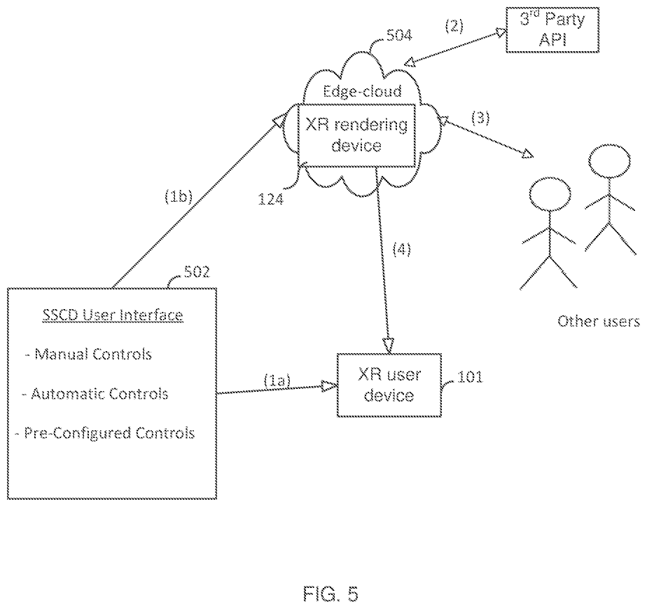

The flow of information, according to one embodiment, is illustrated in FIG. 5. The example illustrated flow includes five potential relays of information. The flow begins with SSCD 199 presenting user interface 502 to the user where the user sets the type of controls that they would like to use to moderate the sensory environment. The SSCD 199 then either directly institutes these controls into the moderation of content generated by XR user device 101 directly (1a) or communicates with an edge-cloud 504 to communicate the necessary permissions to alter the generation of the XR content, access an edge-cloud-based/hosted library of experiences to help identify violating sensory stimuli, or moderate sensory content indirectly (1b). In one embodiment, the library of experiences is an online database recording the expected sensory measurements of particular experiences based on prior measurements, recordings, or user entries (and so on). Thus, a third party may construct and maintain a database of sound information with the following series of variables: sensory emitter (what individual or object in the XR environment produced the sensory stimulus); level (value assigned to the intensity or presence of the stimulus); unit (relevant unit assigned to the level, e.g. decibels or frame rate of strobing light); source of entry (how did this data enter the database); coordinates (spatial location); type of Location (public business, private business, public outdoor space, private outdoor space, theme park, etc); time data collected or recorded (timestamp of when data was captured). This information could then be used to train a model (anything from a really basic classifier to neural networks) predicting potentially violated stimulus in XR environments before or as they are rendered for the end user based on end user's specifications of violating sensations and automatically moderate them in accordance with the end user's moderation preferences.

The SSCD 199 may also need to communicate with third-party APIs in order to directly moderate an experience offered through a third-party service or disclose that they are deactivating or modulating part of the sensory environment (2). Likewise, the SSCD 199 may need to communicate with other users through the edge-cloud or through another form of shared connection to share or obtain permissions to alter the generation of a shared environment or notify them that they are making changes to a shared XR experience (3). Finally, data transmitted to the edge-cloud during this process may be communicated back to XR user device 101 to assist in moderating of sensory experiences in the XR environment (4).

As illustrated herein, SSCD 199 effectively exists as a layer in between the data, media, and services requested by the user and what is ultimately output (e.g., displayed) to the user. The SSCD 199 has some degree of control over the sensory stimulations that are provided to the user (e.g., displayed in screen space or output through other actuators, such as for example, audio, haptics, or other sensory responses). Users define the required degree of control, either by default settings (e.g. no deafening sounds), through an application or service (e.g. an application to eliminate strobing lights), or preference settings (e.g. no audio above 80 dB). Referring to the amount of manual intervention required of users to adjust sensory output, this control layer can be manual, semi-automatic, or fully automatic. This section introduces multiple verities of sensory sensitivity control layers, which vary as a function of how much manual intervention is required. Additionally, SSCD 199 also allows sensory sensitivity controls to be shaped or affected by third party services or APIs. Users may set their policy preferences when turning the headset on for the first time, when launching a new application or service, or when creating a user account.

2.1. Manual Controls

In one embodiment, the sensory sensitivity controls are fully manual. In other words, users must manually request that sensory outputs be moderated. A potential example of a manual intervention includes turning on silent mode where all environmental noise is removed. While automated sensory controls may automatically adjust environmental noise based on user settings, the key distinction with manual controls is that the system does not react unless and until the user requests it to do so. When in manual mode, SSCD 199 may operate in the edge-cloud or on the XR headset 120 (or other component of XR user device 101). In the first case, environmental data sensed by sensor of XR user device 101 are streamed (e.g., via a wireless access network) to the edge-cloud where it is then processed (e.g., processed using a machine learning model or other Artificial Intelligence (Al) unit). Once the processing is complete, the moderated data is then returned to the XR headset. In the second case, environmental data is processed via algorithms that run locally on the XR headset and then displayed.

In order to select features, users would initiate the SSCD 199 through an interaction with their XR user device 101 within the XR environment. They would then select the category of sensory experience in their environment that they would like to manually moderate from a list of the possible sensory experiences that can be moderated within SSCD 199. The SSCD 199 would then generate a list of the potential sensory experiences that could be moderated within the XR environment for the user to manually select and lead the user to either deactivate or otherwise modulate the intensity of that feature. Potential selection triggers include gestures, eye movements, or switches on the headset.

2.2 Automated Controls

In another embodiment, the sensory sensitivity controls are fully automated. In other words, unlike the manual controls, automated controls do not activate in direct response to a user input, but rather activate based on pre-specified and stored user preference information. A potential example of an automatic intervention includes reducing the volume in users' headphones by 20 dB or increase the size of text displayed in screen space based on a pre-specified preference, rather than a real-time preference. Unlike manual controls, these automated adjustments occur without users having to take an action other than, at most, pre-specifying their preferences (e.g. using the user interface 502 shown in FIG. 5). These automated adjustments may be defined by policies set by the user, an application, or service.

When in manual mode, SSCD 199 may operate in the edge-cloud or on the XR headset 120 (or other component of XR user device 101). In the first case, environmental data sensed by sensor of XR user device 101 are streamed (e.g., via a wireless access network) to the edge-cloud where it is then processed (e.g., processed using a machine learning model or other Artificial Intelligence (AI) unit). Once the processing is complete, the moderated data is then returned to the XR headset. In the second case, environmental data is processed via algorithms that run locally on the XR headset and then displayed.

2.3. Semi-Automated Controls.

In another embodiment, the sensory sensitivity controls are semi-automated. Unlike manual controls and automated controls, semi-automated controls only turn on upon user request (e.g. launching an application or service). Unlike manual controls, which require user intervention, semi-automated controls then thereafter operate in a fully automated fashion.

3.0 Setup of Interfacing with Local/Public/Commercial Environments

Owners of physical spaces that are likely to trigger sensory issues may wish to inform potential visitors of this, and pre-emptively trigger modifications of a sensory experience for a visitor. For instance, a venue that uses strobe lights might want to pre-emptively alert users that such lights are likely to be used, and allow users to moderate them. Accordingly, in some embodiments, third parties can provide information about the sensory environments that they either control or have information about. Such interfacing will be helpful in providing additional input to the SSCD 199.

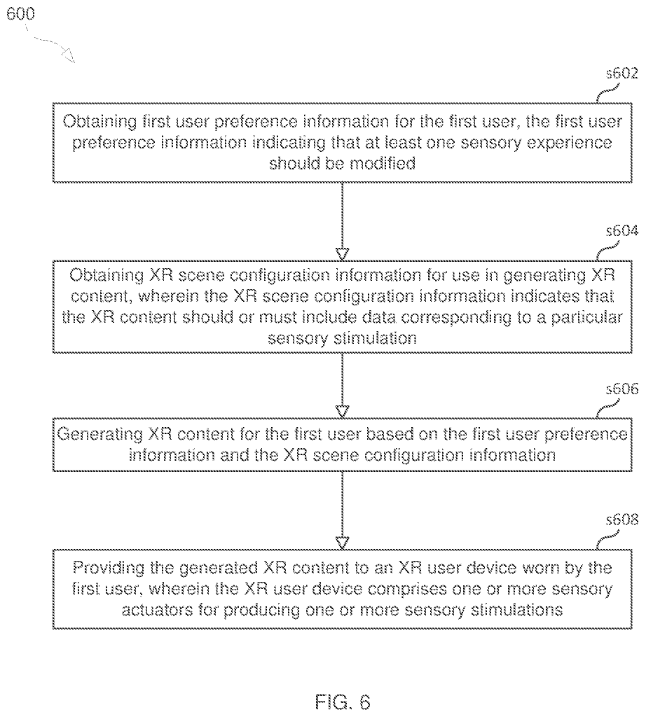

FIG. 6 is a flow chart illustrating a process 600, according to an embodiment, for moderating a first user's sensory experience with respect to an XR environment with which the first user is interacting. Process 600 may be performed by an XR rending device (e.g., XR rendering device 124) having a SSCD (e.g. SSCD 199) and may begin in step s602.

Step s602 comprises obtaining (e.g., retrieving) first user preference information for the first user, the first user preference information indicating that at least one sensory experience should be modified (e.g., blocked, reduced, or increased). For example, in step s602 the XR rendering device may obtain the first user preference information by retrieving the information from user preference database 172. Database 172 can be any type of database (e.g., relational, NoSQL, centralized, distributed, flat file, etc.). In one embodiment, preferences that do not change dynamically (potentially stored as JSON or XML files) could be fetched via HTTP GET. Preferences and responses that change dynamically could be streamed via protocols such as Reliable Datagram Sockets (RDS) or Reliable UDP (RUDP) that are not request-response oriented. The table below illustrates an example piece of preference information.

```
<message from=‘device@example.org’
  to=‘client@example.org/amr’>
  <fields xmlns=‘urn:xmpp:iot:sensordata’ seqnr=‘1’ done=‘true’>
    <node nodeId=‘Device01’>
      <timestamp value=‘2019-03-07T16:24:30’>
        <numeric name=‘maximumDB’ value=‘100’ unit=‘decibels’/>
      </timestamp>
    </node>
  </fields>
</message>
```

Step s604 comprises obtaining XR scene configuration information for use in generating XR content, wherein the XR scene configuration information indicates that the XR content should or must include data corresponding to a particular sensory stimulation. For example, in step s604 the XR rendering device may obtain the XR scene configuration information by retrieving the information from database 171. Database 171 can be any type of database (e.g., relational, NoSQL, centralized, distributed, flat file, etc.). Step s606 comprises generating XR content for the first user based on the first user preference information and the XR scene configuration information. Step s608 comprises providing the generated XR content to an XR user device worn by the first user, wherein the XR user device comprises one or more sensory actuators for producing one or more sensory stimulations. For example, in step s608 the XR rendering device provides the generated content to the XR user device by transmitting the XR content to the XR user device via a network. Any protocol or combination of protocols may be used to transmit the XR content (e.g., DASH, HLS, HTTP). As used herein the phrase “worn by the user” is a broad term that encompasses only items that are placed on the person's body (e.g., a glove, a vest, a suit, goggles, etc.), but items also implanted within the person's body.

In some embodiments, the step of generating the XR content for the first user based on the first user preference information and the XR scene configuration information comprises refraining from including in the generated XR content the data corresponding to the particular sensory stimulation. In some embodiments, the step of generating the XR content for the first user based on the first user preference information and the XR scene configuration information further comprises including in the generated XR content data corresponding to a modified version of the particular sensory stimulation.

In some embodiments, the process also includes obtaining environmental data indicating a sensory stimulation in the first user's physical environment, wherein the generation of the XR content is further based on the environmental data. For example, the environmental data may be received from a sensor.

In some embodiments, obtaining first user preference information comprises obtaining pre-specified first user preference information (as opposed to user preference information specified in real-time) (e.g., the pre-specified first user preference information may be retrieved from user preference database 172).

In some embodiments, the process further includes obtaining XR action information pertaining to a second user with which the first user is interacting within the XR environment, wherein the generation of the XR content is further based on the XR action information pertaining to the second user. For example, the first user and the second user may be virtually arm wrestling. In such a scenario, an action taken by one user may be felt by the other user. For example, if both users are wearing an XR glove, then the first user may feel pressure on their hand when the second user grips the virtual hand of the first user. The first user may pre-specify that they do not want to feel any pressure above a certain threshold. Accordingly, if the second user tries to crush the hand of the first user, then, in some embodiments, the SSCD 199 will detect this and cause the XR rendering device to produce the XR content so that the first user does not sense a pressure above the threshold. Accordingly, in some embodiments, the XR action information pertaining to the second user indicates that the second user has performed an action intended to cause the XR rendering device to produce XR content for producing a particular sensory stimulation for the first user, and the step of generating the XR content for the first user based on the first user preference information, the XR scene configuration information, and the XR action information pertaining to the second user comprises refraining from including in the generated XR content the XR content for producing the particular sensory stimulation (e.g., particular pressure amount). In some embodiments, the step of generating the XR content for the first user based on the first user preference information, the XR scene configuration information, and the XR action information pertaining to the second user further comprises including in the generated XR content data corresponding to a modified version of the particular sensory stimulation (e.g., a lower pressure amount).

In some embodiments, the XR rendering device communicates with the XR user device via a base station. In some embodiments, the XR rendering device is a component of the base station.

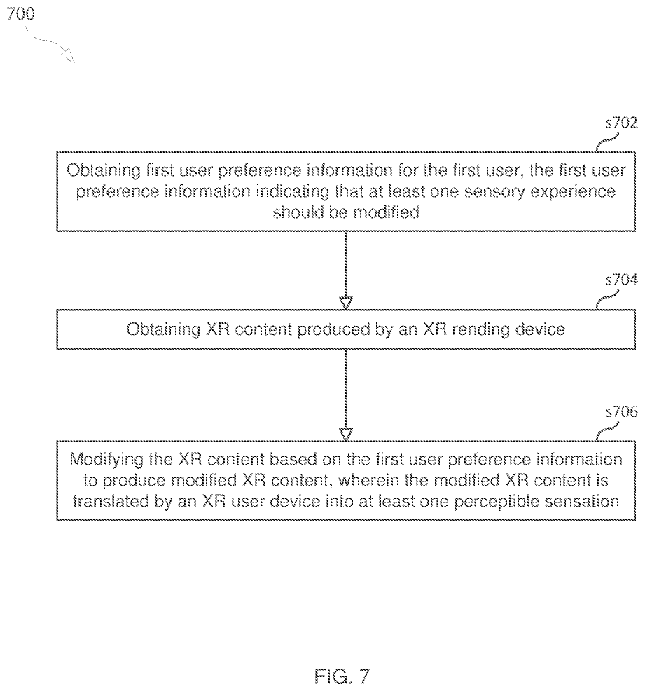

FIG. 7 is a flow chart illustrating a process 700, according to an embodiment, for moderating a first user's sensory experience with respect to an XR environment with which the first user is interacting. Process 700 may be performed by a SSCD (e.g. SSCD 199) and may begin in step s702.

Step s702 comprises obtaining first user preference information for the first user, the first user preference information indicating that at least one sensory experience should be modified (e.g., blocked or reduced or increased). Step s704 comprises obtaining XR content produced by an XR rending device. Step s706 comprises modifying the XR content based on the first user preference information to produce modified XR content, wherein the modified XR content is translated by an XR user device (101) into at least one sensory stimulation.

In some embodiments, the XR content includes data corresponding to a particular sensory stimulation, the first user preference information indicating that at least one sensory experience should be modified comprises sensory control information associated with the particular sensory stimulation, and the step of modifying the XR content based on the first user preference information comprises modifying the XR content such that the data corresponding to the particular sensory stimulation is not included in the modified XR content. In some embodiments, the data corresponding to the particular sensory stimulation was generated by the XR rendering device based on one or more actions performed by a second user with which the first user is interacting in the XR environment. In some embodiments, the step of modifying the XR content based on the first user preference information further comprises including in the modified XR content data corresponding to a modified version of the particular sensory stimulation.

In some embodiments, the process further includes obtaining environmental data indicating a sensory stimulation in the first user's physical environment, wherein the modification of the XR content is further based on the environmental data. For example, the environmental data may be received from a sensor. In some embodiments, obtaining first user preference information comprises obtaining pre-specified first user preference information (e.g., the pre-specified first user preference information may be retrieved from user preference database 172).

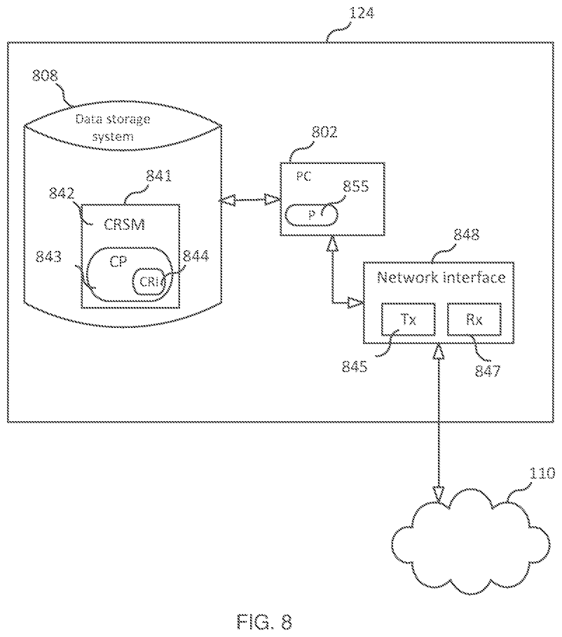

FIG. 8 is a block diagram of XR rendering device 124, according to some embodiments. As shown in FIG. 8, XR rendering device 124 may comprise: processing circuitry (PC) 802, which may include one or more processors (P) 855 (e.g., one or more general purpose microprocessors and/or one or more other processors, such as an application specific integrated circuit (ASIC), field-programmable gate arrays (FPGAs), and the like), which processors may be co-located in a single housing or in a single data center or may be geographically distributed (i.e., XR rendering device 124 may be a distributed computing apparatus); at least one network interface 848 (e.g., a physical interface or air interface) comprising a transmitter (Tx) 845 and a receiver (Rx) 847 for enabling XR rendering device 124 to transmit data to and receive data from other nodes connected to a network 110 (e.g., an Internet Protocol (IP) network) to which network interface 848 is connected (physically or wirelessly) (e.g., network interface 848 may be coupled to an antenna arrangement comprising one or more antennas for enabling XR rendering device 124 to wirelessly transmit/receive data); and a local storage unit (a.k.a., “data storage system”) 808, which may include one or more non-volatile storage devices and/or one or more volatile storage devices. In embodiments where PC 802 includes a programmable processor, a computer program product (CPP) 841 may be provided. CPP 841 is or includes a computer readable storage medium (CRSM) 842 storing a computer program (CP) 843 comprising computer readable instructions (CRI) 844. CRSM 842 may be a non-transitory computer readable medium, such as, magnetic media (e.g., a hard disk), optical media, memory devices (e.g., random access memory, flash memory), and the like. In some embodiments, the CRI 844 of computer program 843 is configured such that when executed by PC 802, the CRI causes XR rendering device 124 to perform steps described herein (e.g., steps described herein with reference to the flow charts). In other embodiments, XR rendering device 124 may be configured to perform steps described herein without the need for code. That is, for example, PC 802 may consist merely of one or more ASICs. Hence, the features of the embodiments described herein may be implemented in hardware and/or software.

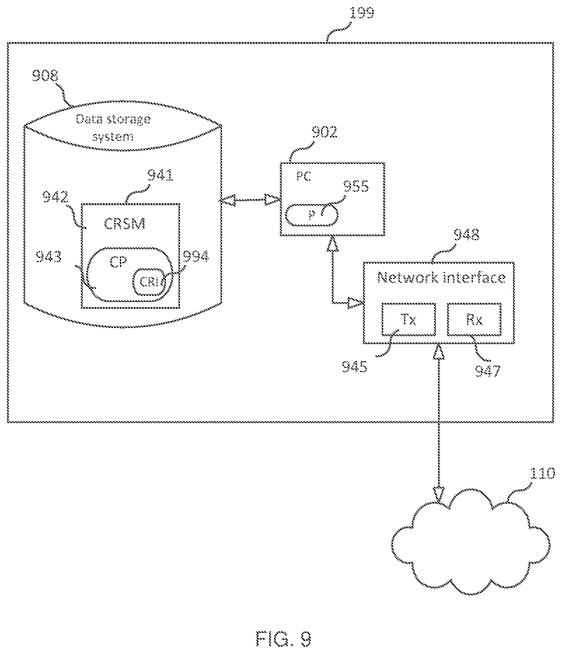

FIG. 9 is a block diagram of SSCD 199, according to some embodiments. As shown in FIG. 9, SSCD 199 may comprise: processing circuitry (PC) 902, which may include one or more processors (P) 955 (e.g., one or more general purpose microprocessors and/or one or more other processors, such as an application specific integrated circuit (ASIC), field-programmable gate arrays (FPGAs), and the like), which processors may be co-located in a single housing or in a single data center or may be geographically distributed (i.e., SSCD 199 may be a distributed computing apparatus); at least one network interface 948 (e.g., a physical interface or air interface) comprising a transmitter (Tx) 945 and a receiver (Rx) 947 for enabling SSCD 199 to transmit data to and receive data from other nodes connected to a network 110 (e.g., an Internet Protocol (IP) network) to which network interface 948 is connected (physically or wirelessly) (e.g., network interface 948 may be coupled to an antenna arrangement comprising one or more antennas for enabling SSCD 199 to wirelessly transmit/receive data); and a local storage unit (a.k.a., “data storage system”) 908, which may include one or more non-volatile storage devices and/or one or more volatile storage devices. In embodiments where PC 902 includes a programmable processor, a computer program product (CPP) 941 may be provided. CPP 941 is or includes a computer readable storage medium (CRSM) 942 storing a computer program (CP) 943 comprising computer readable instructions (CRI) 944. CRSM 942 may be a non-transitory computer readable medium, such as, magnetic media (e.g., a hard disk), optical media, memory devices (e.g., random access memory, flash memory), and the like. In some embodiments, the CRI 944 of computer program 943 is configured such that when executed by PC 902, the CRI causes SSCD 199 to perform steps described herein (e.g., steps described herein with reference to the flow charts). In other embodiments, SSCD 199 may be configured to perform steps described herein without the need for code. That is, for example, PC 902 may consist merely of one or more ASICs. Hence, the features of the embodiments described herein may be implemented in hardware and/or software.

Conclusion

As noted above, the following requirements are missing in existing XR solutions: 1) an interface through which users can select and specify sensory experience preferences, including the moderating (e.g., blocking) of experiences commonly associated with harm in certain populations; 2) a mechanism that tracks and moderates sensory experiences in virtual environments in real time; 3) a function that tracks and moderates sensory experiences in the real-world environment in real time; and 4) an architecture that allows for the identification of these sensory threats and/or nuisances in an user's geographic proximity.

This disclosure, therefore, introduces, in some embodiments, an interface through which users set manual, automatic, or semi-automatic controls that moderate sensory inputs and interactions—including both presently available sensory features that can be digitized like visual and audio data and sensory features like olfactory and taste data that cannot presently be digitized. Additionally, there is provided, in some embodiments, a mechanism through which an SSCD identifies stimuli that fall outside of these thresholds and moderates the sensation to comply with user preferences through visual, audio, or wearable settings in XR user device itself.

In addition to these two features, this disclosure introduces, in some embodiments, an architecture through which XR devices can use data from third party APIs, their device history, or other user data to flag and warn users of potentially harmful or discomforting stimuli in geographic space. By drawing on a library of sensory experiences locally and extra-locally, then mapping them to physical spaces identifiable to users using their XR or other enabled device, one can help users make safer and more informed decisions about the content with which they engage in virtual and real-world circumstances.

In short, an objective of this disclosure is to make XR experiences safer, more accessible, and more enjoyable to a larger audience of potential consumers of this technology. A sensory sensitivity control device (SSCD) not only makes experiences in XR safer for the millions of people living with a sensory-affecting disability worldwide, but it also makes XR experiences more comfortable for non-disabled users who have even weak preferences over the intensity of sensory experiences in virtual spaces. Beyond the virtual domain, this function and architecture may be used by both audiences to interact more safely and comfortably in physical environments where they might otherwise be compromised or made uncomfortable by sensory stimulation.

This objective is achieved by extending XR functionality and introducing new ways for users to comfortably and safely experience the benefits of XR technology. This is thanks to: 1) the ability to moderate undesired sensory stimulation in an user's virtual or physical reality and 2) the flexibility to allow users to manually select particular sensory features or automatically identify a range of features that pose a threat to user comfort or safety. Additionally, the proposed architecture has the following advantages. 1) Speed: pairing 5G NR with edge-cloud computing will allow the dynamic moderation of sensory data and the translation of this data into safe and comfortable experiences; 2) Scalability: the architecture is scalable since it is edge-cloud-ready; 3) Flexibility: the mapping, sensory experience sharing, and sensory experience identification architecture is flexible since the mapping and identification of sensory experiences can be done using any type of network-connected device; 4) Accessibility: the unprecedented degree of user control over which sensory stimuli to which they are exposed greatly expands the accessibility of XR technology to millions of people vulnerable to sensory sensitivity disorders that typically accompany some autism spectrum and epileptic conditions; it also extends this technology to the millions of people with strict personal preferences over their exposure to certain sensory content; and 5) Safety: by providing this control to users, this invention makes interactions in both the virtual and real world safer to the millions of individuals with sensory sensitivities that pose a risk to their well-being.

While various embodiments are described herein, it should be understood that they have been presented by way of example only, and not limitation. Thus, the breadth and scope of this disclosure should not be limited by any of the above-described exemplary embodiments. Moreover, any combination of the above-described elements in all possible variations thereof is encompassed by the disclosure unless otherwise indicated herein or otherwise clearly contradicted by context.

Additionally, while the processes described above and illustrated in the drawings are shown as a sequence of steps, this was done solely for the sake of illustration. Accordingly, it is contemplated that some steps may be added, some steps may be omitted, the order of the steps may be re-arranged, and some steps may be performed in parallel.

1. A method, performed by an extended reality, (XR) rending device having a sensory sensitivity control device, for moderating a first user's sensory experience with respect to an XR environment with which the first user is interacting, the method comprising:
obtaining first user preference information for the first user, the first user preference information indicating that at least one sensory experience should be modified;
obtaining XR scene configuration information for use in generating XR content, wherein the XR scene configuration information indicates that the XR content should or must include data corresponding to a particular sensory stimulation;
generating XR content for the first user based on the first user preference information and the XR scene configuration information; and
providing the generated XR content to an XR user device worn by the first user, wherein the XR user device comprises one or more sensory actuators for producing one or more sensory stimulations.

2. The method of claim 1, wherein
the step of generating the XR content for the first user based on the first user preference information and the XR scene configuration information comprises refraining from including in the generated XR content the data corresponding to the particular sensory stimulation.

3. The method of claim 2, wherein
the step of generating the XR content for the first user based on the first user preference information and the XR scene configuration information further comprises including in the generated XR content data corresponding to a modified version of the particular sensory stimulation.

4. The method of claim 1, further comprising:
obtaining environmental data indicating a sensory stimulation in the first user's physical environment, wherein
the generation of the XR content is further based on the environmental data.

5. The method of claim 1, wherein obtaining first user preference information comprises obtaining pre-specified first user preference information.

6. The method of claim 1, further comprising:
obtaining XR action information pertaining to a second user with which the first user is interacting within the XR environment, wherein
the generation of the XR content is further based on the XR action information pertaining to the second user.

7. The method of claim 6, wherein
the XR action information pertaining to the second user indicates that the second user has performed an action intended to cause the XR rendering device to produce XR content for producing a particular sensory stimulation for the first user, and
the generation of the XR content for the first user based on the first user preference information, the XR scene configuration information, and the XR action information pertaining to the second user comprises refraining from including in the generated XR content the XR content for producing the particular sensory stimulation.

8. The method of claim 7, wherein
the generation of the XR content for the first user based on the first user preference information, the XR scene configuration information, and the XR action information pertaining to the second user further comprises including in the generated XR content data corresponding to a modified version of the particular sensory stimulation.

9. The method of claim 1, wherein the XR rendering device communicates with the XR user device via a base station.

10. The method of claim 9, wherein the XR rendering device is a component of the base station.

11. A method, performed by a sensory sensitivity control device, for moderating a first user's sensory experience with respect to an extended reality XR environment with which the first user is interacting, the method comprising:
obtaining first user preference information for the first user, the first user preference information indicating that at least one sensory experience should be modified;
obtaining XR content produced by an XR rending device; and
modifying the XR content based on the first user preference information to produce modified XR content, wherein the modified XR content is translated by an XR user device into at least one sensory stimulation.

12. The method of claim 11, wherein
the XR content includes data corresponding to a particular sensory stimulation,
the first user preference information indicating that at least one sensory experience should be modified comprises sensory control information associated with the particular sensory stimulation, and
the step of modifying the XR content based on the first user preference information comprises modifying the XR content such that the data corresponding to the particular sensory stimulation is not included in the modified XR content.

13. The method of claim 12, wherein the data corresponding to the particular sensory stimulation was generated by the XR rendering device based on one or more actions performed by a second user with which the first user is interacting in the XR environment.

14. The method of claim 12, wherein
the step of modifying the XR content based on the first user preference information further comprises including in the modified XR content data corresponding to a modified version of the particular sensory stimulation.

15. The method of claim 11, further comprising:
obtaining environmental data indicating a sensory stimulation in the first user's physical environment, wherein
the modification of the XR content is further based on the environmental data.

16. The method of claim 11, wherein obtaining first user preference information comprises obtaining pre-specified first user preference information.

17. A computer program product comprising a non-transitory computer readable medium storing a computer program comprising instructions which when executed by processing circuitry of an extended reality (XR) rendering device, causes the XR rendering device to perform the method of claim 1.

18. (canceled)

19. An extended reality, (XR) rendering device, the XR rendering device comprising:
processing circuitry; and
a memory, the memory containing instructions executable by the processing circuitry, whereby the XR rendering device is configured to perform a process comprising:
obtaining first user preference information for a first user, the first user preference information indicating that at least one sensory experience should be modified;
obtaining XR scene configuration information for use in generating XR content, wherein the XR scene configuration information indicates that the XR content should or must include data corresponding to a particular sensory stimulation;
generating XR content for the first user based on the first user preference information and the XR scene configuration information; and
providing the generated XR content to an XR user device worn by the first user, wherein the XR user device comprises one or more sensory actuators for producing one or more sensory stimulations.

20. (canceled)

21. A computer program product comprising a non-transitory computer readable medium storing a computer program comprising instructions which when executed by processing circuitry of sensory sensitivity control device, (SSCD) causes the SSCD to perform the method of claim 11.

22. (canceled)

23. (canceled)

24. A sensory sensitivity control device, SSCD, the SSCD comprising:
processing circuitry; and
a memory, the memory containing instructions executable by the processing circuitry, whereby the SSCD is configured to perform a process comprising:
obtaining first user preference information for a first user, the first user preference information indicating that at least one sensory experience should be modified;
obtaining XR content produced by an XR rending device; and
modifying the XR content based on the first user preference information to produce modified XR content, wherein the modified XR content is translated by an XR user device into at least one sensory stimulation.
